(19) United States
(12) Patent Application Publication
(10) Pub. No.: US 2012/0323975 A1
(43) Pub. Date: Dec. 20, 2012

(54) PRESENTATION SOFTWARE AUTOMATION SERVICES

(75) Inventors: Harshal Ingole, San Jose, CA (US); Rebecca Loew, Mountain View, CA (US); Christian Yang, Sunnyvale, CA (US); Cameron Kikoen, Mountain View, CA (US)

(73) Assignee: Microsoft Corporation, Redmond, WA (US)

(21) Appl. No.: 13/160,975

(22) Filed: Jun. 15, 2011

(51) Int. Cl. G06F 17/30

(52) U.S. Cl. 707/809; 707/E17.044

(57) ABSTRACT

Embodiments are disclosed for performing automation services. Automation services are, in embodiments, applications, processes, or systems capable of converting an initial file into a converted file having a different file type from the initial file. In embodiments, a requestor generates a conversion request message. The conversion request message may contain information about the desired conversion, options to be performed during the conversion, and an initial file that is to be converted. The initial file may be represented by a data stream that is part of the request message. The request message is sent to a file converter that performs the desired request on the data stream to create a converted file.

### BACKGROUND

Some presentation applications provide users with an option to convert the presentation file type to a different file type. In order to use this option users have to individually open and convert each file using the presentation application. However, there are situations in which a user desires to convert a large number of presentation files into different file formats. This is particularly true in a business setting where a company may want to convert a large number of stored presentations into different file formats. In these situations, it is not efficient to use the conversion option provided by the presentation application to convert a large number of presentation files. It is with respect to this general environment that embodiments of the present disclosure have been contemplated.

Although specific problems have been addressed in this Background, this disclosure is not intended in any way to be limited to solving those specific problems.

### SUMMARY

Embodiments are disclosed for performing automation services. Automation services are in embodiments applications, processes, or systems capable of converting an initial file into a converted file having a different file type from the initial file. For example, an automation service may be employed to convert a presentation file, such as a POWERPOINT™ (.ppt) file or and Open Office XML Presentation file (.pptx) into a converted file (e.g., a PDF file, an XPS file, a JPEG file, a PNG file, or any other type of file).

In embodiments, a requestor generates a conversion request message. The conversion request message may contain information about the desired conversion, options to be performed during the conversion, and an initial file that is to be converted. The initial file may be represented by a data stream that is part of the request message. The request message is sent to a file converter that performs the desired request on the data stream to create a converted file. The converted file is then returned to the requestor. In additional embodiments, the file converter may prioritize requests. For example, the file converter may prioritize single file conversion requests over requests to convert batch files.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The same number represents the same element or same type of element in all drawings.

FIG. 1 illustrates an embodiment of a system 100 for performing automation services.

FIG. 2 is an illustration of a flowchart representing an embodiment of a method 200 for generating and sending an automation request.

FIG. 3 is an illustration of a flowchart representing an embodiment of a method 300 responding to an automation request.

FIG. 4 is an illustration of flowchart representing an embodiment of a method 400 for processing multiple automation requests.

FIG. 5 illustrates an embodiment of a computer environment and computer system 500 for implementing the methods disclosed herein.

### DETAILED DESCRIPTION

This disclosure will now more fully describe exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

Embodiments of systems and methods are disclosed for performing automation services. Automation services are applications, processes, or systems capable of converting an initial file into a converted file having a different file type from the initial file. For example, an automation service may be employed to convert a presentation file, such as a POWERPOINT™ (.ppt) file or and Open Office XML Presentation file (.pptx) into a converted file (e.g., a PDF file, an XPS file, a JPEG file, a PNG file, or any other type of different file).

In embodiments, a requestor generates a conversion request message. The conversion request message may contain information about the desired conversion, options to be performed during the conversion, and an initial file that is to be converted. The initial file may be represented by a data stream that is part of the request message. The request message is sent to a file converter that performs the conversion request on the data stream to create a converted file. The converted file is then returned to the requestor. In additional embodiments, the file converter prioritizes requests. For example, the file converter may prioritize single file conversion requests over requests to convert batch files.

For example, the systems and methods disclosed herein may be used to convert a presentation file (e.g., an Open Office XML Presentation (.pptx) file, a POWERPOINT™ Presentation (.ppt) file, or any other type of presentation file) into a converted file having a different file type. In embodiments, a converted file type is a file type other than the original file type. For example, the converted file type may be, but is not limited to, one of the following file types: an Open Office XML Presentation (.pptx) file, a POWERPOINT™ Presentation (.ppt) file, a Portable Document Format (.pdf) file, an XML Paper Specification (.xps) file, a JPEG (.jpg) file, and/or a Portable Network Graphics (.png) file. In certain embodiments, when converting a presentation file to an image file, such as a .jpg file or a .png file, an individual image may be generated for each slide or page of the presentation. These individual files may then in some embodiments be grouped together in a compressed file (e.g., a zip file, a tar file, a .gz, file, 0.7z file, or any other type of compressed file).

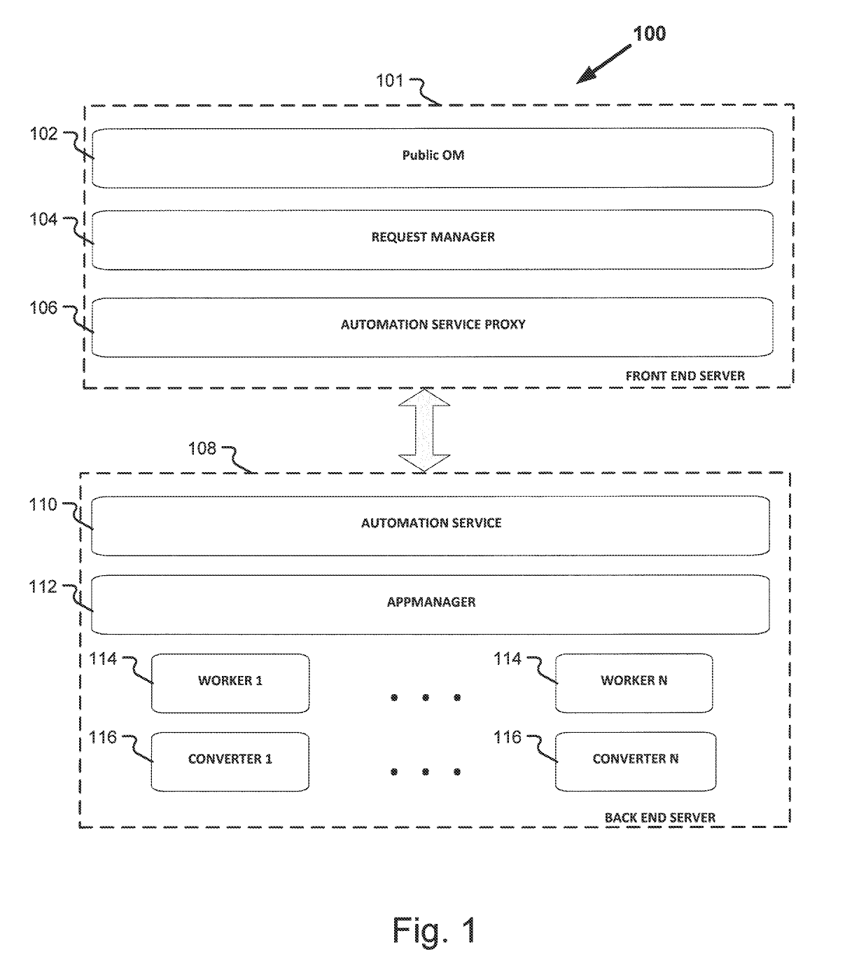

Referring now to the figures, FIG. 1 illustrates an embodiment of a system 100 for performing automation services. In embodiments, automation services are services that convert an initial file into a converted file having a different file type. System 100 may be part of a networked system, a web service platform, such as, but not limited to, a platform such as MICROSOFT™ SHAREPOINT™, or any other type of computing environment. In embodiments, the system comprises a front end server 101 and a back end server 108. The front end server 101 may include a Public Object Model (“Public OM”) 102 that provides the logic for generating a file conversion request, such as, for example, a request to convert a presentation file. In embodiments, the Public OM 102 is an application programming interface (“API”) that a requestor (e.g., a user, developer, application, process, etc.) can utilized in order to create a file conversion request. For example, in one embodiment, the Public OM 102 provides a generic method for requesting a file conversion. In such embodiments, the generic method may be called regardless of what type of converted file is ultimately created. In other embodiments, the Public OM 102 may provide a specific conversion method for each type of desired converted file type. For example, the Public OM 102 may provide a specific method to convert a presentation file into a .pdf file, a different method to convert the presentation file into a .jpg file, etc. In such embodiments, the Public OM 102 may expose a different method for every file type conversion.

In embodiments, the methods provided to generate requests for file conversion may accept input parameters. For example, the methods may accept a file, such as a presentation file, as an input parameter. In one embodiment, the file itself is provided as input to the method. For example, the method may be provided the path to an initial file that is to be converted. In such circumstances, the method may then use the path information to access the file. In other embodiments, the method may receive a data stream representing the initial file. Utilizing a data stream provides additional efficiencies for the file conversion automation service. If the initial files are provided as a stream, it allows the automation service to perform file conversions on the data stream without having to allocate memory to store the initial file and the converted file. Upon converting the stream, the automation service can pass the converted file, in the form of a data stream, back to the requestor.

In embodiments, whether the Public OM 102 accepts an input path or a stream depends on the number of files provided in the input. For example, a single file may be provided as either an input path or a stream. However, a whole folder or a network list, such as, but not limited to, a SHAREPOINT™ list, such groups of objects may be provided with path data that provides the location of the initial files and the location to write the converted files. In other embodiments, such as when the Public OM 102 provides a generic conversion method as described above, the method also receives information, for example, in the form of a parameter that indicates the type of file conversion desired by the requestor.

In still another embodiment, the methods provided by the Public OM 102 receive information related to conversion options. For example, depending on the type of converted file requested, the requestor may indicate that the automation service may perform additional actions during the conversion process. For example, in an embodiment in which a requestor requests that a presentation file is converted into an image or a series of images, the requestor may specify the size of the image, the resolution of the image, or any number of other image related options. In another embodiment in which a requestor requests that a presentation file is converted into a .pdf file, the requestor may request the number of slides per page, whether or not to include notes from the presentation file in the converted .pdf file or an .xps file, whether the converted file is in the PDF/A format, whether the resulting converted file is created using standard or high quality, whether or not to include hidden slides, whether to frame the slides or not, or any other types of specifications or options commonly employed when creating .pdf files. In other embodiments, the method may receive options related to including or removing metadata, whether the converted file is compressed, or any other type of option that is provided when creating a certain type of file.

The automation service may also provide document inspection options that a requestor can make use of to remove certain data from a file, such as a presentation file, during the file conversion. In embodiments, the automation service may provide the option to automatically remove information. For example, the automation service may provide options that the requestor can select to determine whether or not to include certain information in the converted file. Such information may include: comments and annotations, documents properties and PII, custom XML, invisible on-slide content, off-slide content, and/or presentation notes.

In addition to providing methods to generate a request for a file conversion, the Public OM 102 may provide additional methods that are used to perform automation services for file conversion. For example, the Public OM 102 may provide an initiation method (e.g., a “Begin” or “Start” method) to begin the automation service, for example, by calling an automation service or by sending a request to another process to perform the automation service. Other methods provided by the public OM 102 may include a termination method (e.g., an “End” method) that is used to complete the automation service. For example, in one embodiment, the termination method may notify the requestor that the automation service had completed. In such embodiments, the termination method may also provide one or more converted files to the requestor. In another embodiment, if the automation service file conversion fails, the termination service may inform the requestor of the failure for example, by passing an error message back to the requestor.

In embodiments, the Public OM 102 uses an asynchronous pattern method, which handles notifications. By employing an asynchronous pattern method, the requestor does not have to monitor the status of the file conversion request while the conversion is taking place. It allows the requestor to perform another task while waiting for the file conversion. Additionally, the asynchronous pattern method allows the requestor to make the file conversion request to the automation service without blocking resources.

In embodiments, before a requestor can provide the initial file to the automation service and generate requests using the Public OM 102, validation and security checks are performed on the requestor. For example, the requestor may have to perform authentication and authorization checks to ensure that the requestor has the proper set of permissions to access the initial file(s) or directory. In one embodiment, validation and security checks are performed before the requestor accesses the Public OM 102. In another embodiment, the Public OM 102 may perform the validation and security checks.

The front end server 101 may also include a Request Manager 104. The Request Manager 104 may communicate with the Public OM 102 or any application that uses the Public OM 102. The Request Manager 104 sends the request to a back end server 108. In embodiments, although not shown in FIG. 1, the automation service may be a distributed service that spans multiple servers. In such embodiments, multiple back end servers 108 may be employed in system 100. In distributed embodiments, the Request Manager 104 may determine which back end server 108 to send the request to by performing load balancing. For example, the Request Manager 104 may use consistent hashing to distribute requests among back end servers 108. In further embodiments, the Request Manager 104 may also perform failover methods in situations in which the front end server 101 loses its connection to the back end server 108 or if the back end server 108 goes down. The Request Manager 104 may also retry sending messages in cases when the request message is not properly delivered to the back end server 108.

In embodiments, front end server 101 also includes an Automation Service Proxy 106 that is used to establish communications between the Automation Service 110 located on the back end server 108 and the front end server 101. The automation service proxy 106 may be a Windows Communication Foundation (“WCF”) proxy. The WCF proxy may be used to access the Automation Service 110 on the back end server 108. In another embodiment, the Automation Service Proxy 106 may be any other type of proxy or API that is capable of providing communication with and/or access to remote applications.

System 100 also includes a back end server 108. In embodiments, the back end server 108 contains the applications and/or processes that perform the automation service file conversion. The back end server 108 receives conversion requests from the front end server 102 and performs the automation service to convert the files into a new file type. In embodiments, the back end server 108 receives the initial file or files for conversion in a data stream. The processes on the back end server 108 operate on the data stream to create converted files and then pass the converted files back to the requestor, via the front end server, as a converted file data stream. Operating on data streams results in storage efficiency by relieving the back end server 108 from having to save either the initial file or the converted file.

In embodiments, the back end server 108 includes an Automation Service 110. The Automation Service 110 facilitates communication with the web front end server 101 via the Automation Service Proxy 106. For example, the Automation Service 110 receives the request for file conversion and, in the case of a successful, conversion, returns the converted file to the web front end server 101. If the conversion is not successful, the Automation Service 110 may communicate an error code to the front end server 101. In one embodiment, the error code may be a unique error code that corresponds to the type of error that resulted. The error code may include information pertaining to why the file conversion was not successful. In further embodiments, the Automation Service 110 may be a WCF endpoint. In such embodiments, the Automation Service 110 has an address and specifies a binding and a contract that front end server 101 can use to contact the automation service. In other embodiments, the Automation Service 110 may be any type of remotely accessible application capable of receiving requests and communicating responses back to a requestor.

The back end server 108 may also include an AppManager 112. The AppManager 112 may be used to select an appropriate process, such as Converter 116, to perform the requested file conversion. As illustrated in FIG. 1, the back end server 108 may include multiple Converter 116 processes that may be used to perform the requested file conversion. Additionally, the back end server 108 may include Workers 114, such as Worker 1 through Worker N. In embodiments, the Workers 114 may be a wrapper to the Converter 116 processes that facilitate communication between the AppManager 112 and the one or more Converter 116 processes.

In one embodiment, the back end server runs multiple Converter 116 processes to perform file conversions, such as converting a presentation file into a different file format. Each Converter 116 may be capable of performing a single file conversion at a time. Thus, the back end server 108 provides multiple Converters 116 are used to handle a large number of file requests simultaneously. In such embodiments, upon receiving the request, the back end server 108 utilizes the AppManager 112 to determine if there are idle Converters 116 that are not in use. If there is an idle Converter 116 the AppManager 112 directs the request to the idle process. In an embodiment, directing the request to the idle Converter 116 may include providing the request, any request options, and the initial file or a data stream.

In one embodiment, each Converter 116 is capable of performing any supported type of file conversion on the initial file. In another embodiment, different Converters 166 may be used to perform different types of file conversions. In such embodiments, in addition to identifying an idle Converter 116, the AppManager 112 identifies a proper converter to send the request to (e.g., a converter capable of performing the requested conversion type).

In embodiments, the file conversion provided by the automation services is performed by the Converters 116. For example, a Converter 116 receives the initial file (or a data stream containing the initial file) and any requested conversion options, and generates a converted file. The back end server 108 returns the converted file to the requester by passing the converted file back to the front end server 101 via the Automation Service 110. The front end server 101 may then store the converted file for the requestor or provide the converted file back to the requestor.

While FIG. 1 illustrates a system 100 that performs automation services for file conversion using a front end server 101 and a back end server 108, one of skill in the art will appreciate that automation services may be performed in systems that have fewer or more servers. For example, all of the processes and/or modules described in FIG. 1 may be performed by a single server, or three or more servers. In embodiments, the processes may be performed by software instructions residing in computer storage media that perform automation services when executed by a processor. In another embodiment, the processes and/or methods described in FIG. 1 may be implemented in hardware. Additionally, while FIG. 1 describes specific modules, e.g., Request Manager 104, AppManager 112, etc., the functionality described with respect to system 100 may be performed using fewer or more modules than illustrated in FIG. 1.

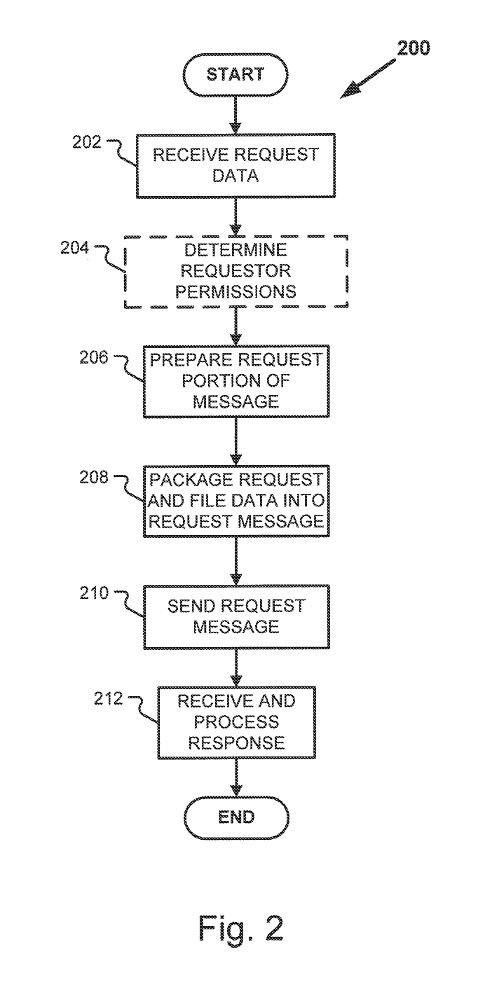

Having described a system for performing automation services, FIGS. 2-4 illustrate various embodiments of methods that may be employed to perform automation services. FIG. 2 illustrates of a flowchart representing an embodiment of a method 200 for generating and sending an automation request. The method 200 may be performed by a system, application, or process to request a file conversion. For example, the method 200 may be performed by a request generator such as an application or process, or a server that is a part of a network, such as front end server 101. Flow begins with operation 202 where the method 200 receives request data from a requestor. A requestor may be a user, application, or process requesting a file conversion, such as, but not limited to, converting a presentation file into another file type. In embodiments, the request data may include information related to the type of request, the initial file data, the initial file type, the desired conversion file type, conversion file data (e.g., the name, location, type, etc. of the conversion file), or any other type of information that may be of use to the automation process.

After receiving the request data, flow optionally proceeds to operation 204 where the method 200 optionally determines the requestor's permissions. For example, at optional operation 204 the method 200 may verify the requestor's authenticity, verify that the requestor is authorized to access the initial file or create the converted file, perform validation functions, perform security checks, etc. In another embodiment, the requestor's permissions are checked and validated before the requestor is able to request the data conversion. In such an embodiment, optional step 204 is not performed by the method 200.

If the requestor's permissions are validated at operation 204, or if the user's permissions were validated prior the start of method 200, flow continues to operation 206. At operation 206, the method prepares the request portion of a request message. In embodiments, an automation service request may contain multiple parts. One part of the request message may be a request portion. In such embodiments, the request portion of the message may include a request for a new converted file type, conversion options, or any other type of request related information.

Flow continues to operation 208 where the request data is packaged with the initial file data to create the request message. In embodiments, the request message includes request data as well as the initial file that is to be converted. In one embodiment, the initial file may be provided by including the path to the file in the request message at operation 208. In another embodiment, the initial file data may be represented as a data stream that is packaged with the request data to be sent as a request message. After packaging the request data and the file data and thereby generating the request message, flow continues to operation 210 where the request message is sent to the automation service. In one embodiment, sending the request message to the automated service comprises sending the message to any number of applications or processes that perform automation services. In one embodiment, the automation services may be located on the same machine as the requestor and/or requesting application. In another embodiment, the automated services may be located on different servers. In such embodiments, sending the request message at operation 210 may utilize a communication module, such as Automation Service Proxy 106 to facilitate communication with a remote machine.

After sending the request message, flow continues to operation 212 where the request generator receives a response to the request. In embodiments, the automation service utilizes an asynchronous pattern method which provides notifications to the request generator. That frees the request generator from having to monitor the status of the conversion request and allows the request generator to perform other tasks while waiting for a response to the request. However, in another embodiment, the request generator performing method 200 may actually monitor the status of the request at operation 212.

The response to the request may be a converted file or it may be an error code. If the response includes a converted file, the converted file is processed at operation 212. Processing the converted file may include sending the file to a requestor, storing the file, accessing the file and displaying it to a user, and/or modifying the file. If the response includes an error code instead a converted file at operation 212, processing the response may include resending the request. In embodiments, the error code may be a unique error code that provides additional information containing the reason(s) for the failed conversion. If the request generator receives an error code, it may address the errors before resending the request. Addressing the errors may include modifying the request or generating and new request and sending the new request.

While the method 200 has been described as including discreet operations, one of skill in the art will appreciate that the operations described in FIG. 2 may be combined together or broken apart resulting in fewer or more operations that are still capable of performing the embodiments described with respect to method 200. Furthermore, one of skill in the art will appreciate that, while the method 200 has been described in a particular order, the order of the operations may be rearranged while still performing embodiments of the method disclosed in FIG. 2.

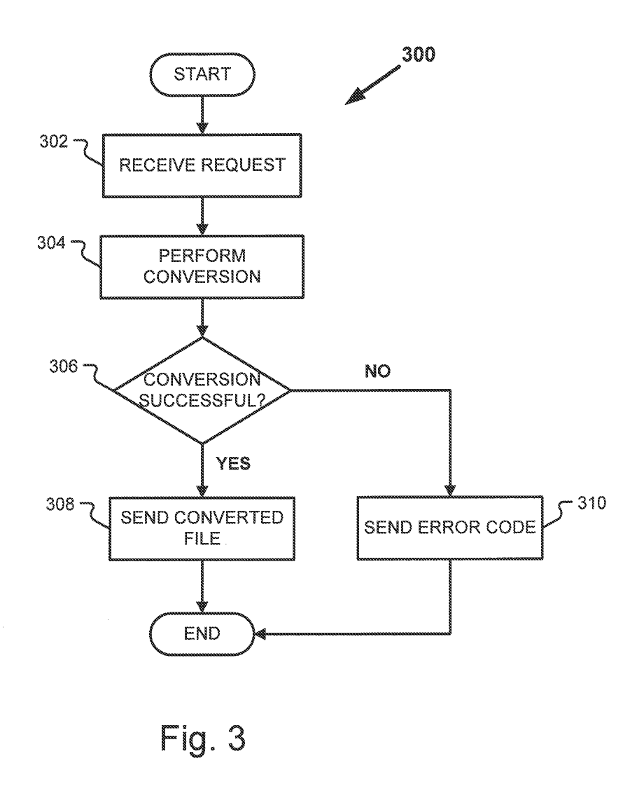

FIG. 3 is an illustration of a flowchart representing an embodiment of a method 300 responding to an automation request. In embodiments, the method 300 may be practiced by a file converter. The file converter may be an application, a process, a machine, or any other device capable of performing the operations described in FIG. 3. For example, the method 300 may be performed by the back end server 108 and/or one or more of the modules previously discussed with respect to FIG. 1. Flow begins at operation 302 where the method 300 receives a request for a file conversion. In embodiments, the request may include a request message that contains information regarding the request and/or an initial file that is to be converted. In embodiments, the initial file is received in a data stream that the method 300 can perform the conversion on. This allows the method to convert the initial file without saving a copy of the initial file locally.

In response to receiving the request, flow continues to operation 304 where the file conversion is performed. For example, a presentation file, such as, but not limited to .ppt and .pptx files, may be converted into a different file type (e.g., a .pdf file, a .xps, file, a .jpg file, a .png file, or compressed file that includes a number of .jpg or .png files, or any other file type). In another embodiment, the file converter may also convert a .ppt file into a .pptx file or a .pptx file into a .ppt file. In further embodiments, the file converter may also perform conversion options, such as, but not limited to, setting image size and resolution and adding or removing information.

After the conversion process, flow proceeds to decision operation 306 where the method 300 determines whether the conversion was successful. If the conversion was successful, flow branches YES to operation 308 and the converted file is sent to the requestor. For example, in embodiments where the conversion operated on a data stream, the data stream can be sent back to the requestor. In one embodiment, if the conversion was not successful, flow branches NO to operation 310 and the method 300 returns an error code to the requestor. In embodiments, the error code informs the requestor that the conversion failed and includes information as to why the conversion was not successful.

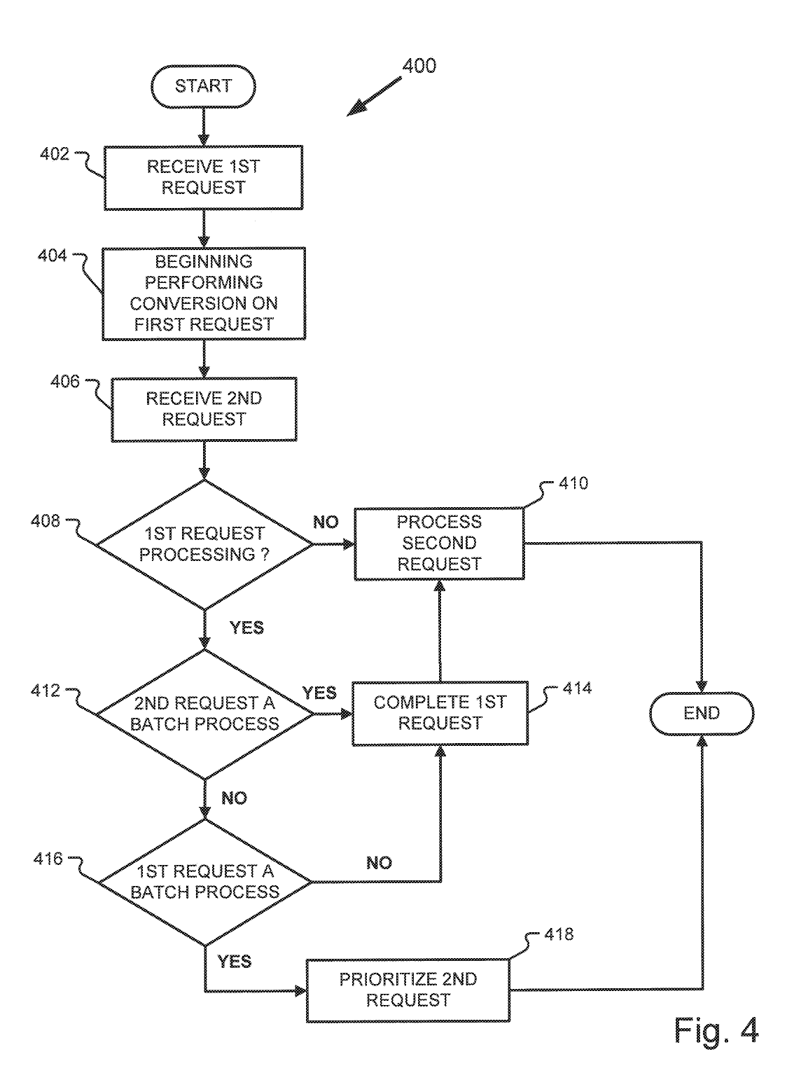

FIG. 4 is an illustration of a flowchart representing an embodiment of a method 400 for processing multiple automation requests. In embodiments, the method 400 may be practiced by a file converter. The file converter may be an application, a process, a machine, or any other device capable of performing the operations described in FIG. 4. For example, the method 400 may be performed by the back end server 100 and/or one or more of the modules previously discussed with respect to FIG. 1.

Flow begins at operation 402 where the file converter receives a first request from a requestor. The request may include a request message that contains information regarding the request and/or an initial file that is to be converted. In embodiments, the initial file is received in a data stream on which the method 400 can perform the conversion. This allows the method to convert the initial file without saving a copy of the initial file locally. In further embodiments, the request may include a number of files that need conversion. For example, the request may include a batch request to convert multiple files. Flow proceeds to operation 404 where the file converter begins converting the one or more files received in operation 402. Again, as an example, one or more presentation files, such as, but not limited to .ppt and .pptx files, may be converted into a different file type (e.g., a .pdf file, a .xps, file, a .jpg file, a .png file, or compressed file that includes a number of .jpg or .png files, or any other file type). In another embodiment, the file converter may also convert a .ppt file into a .pptx file or a .pptx file into a .ppt file. In further embodiments, the file converter may also perform conversion options, such as, but not limited to, setting image size and resolution and adding or removing information.

At a later point in time, the file requestor receives a second request for file conversion from a requestor. The requestor may be the same or a different requestor than the one that generated the first request received at operation 402. As discussed with respect to FIG. 1 a file converter such as the back end server 100 may include multiple file conversion processes. However, the multiple processes may all be engaged in a file conversion process, for example, if each process is engaged in converting a batch of files. Generally, when a requestor requests a batch conversion, the requestor is not expecting the conversion to immediately complete. In such circumstances, the requestor may not expect to access any converted files until all files have been converted. On the other hand, a request for a single file conversion might need immediate access to the converted files. For example, the requestor may be an application that needs to perform a task on the file, such as processing or displaying the file, but cannot do so in the current format. The requestor makes a request for a file format conversion so it can perform its task. In such circumstances, the requestors need for the converted file may be immediate. However, the file converter may be engaged in batch conversions for requestors that do not immediately need a converted file. This results in undue delay for the later requestor.

In order to alleviate this problem, the file converter may prioritize requests for single files over requests for a batch of files. To accomplish prioritization, flow continues to operation 408 where the file converter determines if the first requests (or a number of earlier requests) are still processing or in progress. If the first request has finished, or if any individual file conversion process (e.g., Converter 116) is idle, flow branches NO to operation 410 and the second request is processed (e.g., the second file is converted).

If the first request is still processing, or if there are no idle conversion processes, flow branches YES to operation 412. At operation 412 a determination is made as to whether the second request is for a conversion of a batch of files. If the second request is for a batch conversion, the outlined problem is most likely not an issue because the requestor likely expects the conversion to take some time to complete. In this instance, flow branches YES to operation 414. In this circumstance, the second request (e.g., the later request in time) may wait for the first conversion to complete at operation 414. After the first operation completes, or as soon as a conversion processes becomes idle, flow continues to operation 410 where the file converter performs the second requested file conversion and then method completes.

If the second conversion is not a batch request, the requestor may be expecting quick receipt of the converted file. In this case, flow branches NO from decision operation 412 to decision operation 416. At decision operation 416 the file converter determines whether the first process (or all the earlier in time processes) are for batch conversions. If none of the earlier requests are for batch processes, all of the earlier requestors may be expecting quick receipt of their converted files. In this instance the second request (e.g., the later in time request) may wait its turn. Flow branches NO to operation 414. After the first operation completes, or as soon as a conversion processes becomes idle and the second process is next in line for processing, flow continues to operation 410 where the file converter performs the second requested file conversion and then the method completes.

If the first process is a batch process, then flow branches YES to operation 418 and the second process is prioritized over the first process. In one embodiment, if the first request is still waiting for an available file converter process, prioritization may comprise placing the second request ahead of the first request in the processing order. In another embodiment, if the first process is currently being processed, the processing may be paused to free a file conversion process to handle the second request. Upon completion of the second request, the first conversion may continue. The method 400 alleviates undue delay by processing requests from requestors that expect a quick response before converting or completing the conversion for requests for requestors that do not expect quick delivery of converted files.

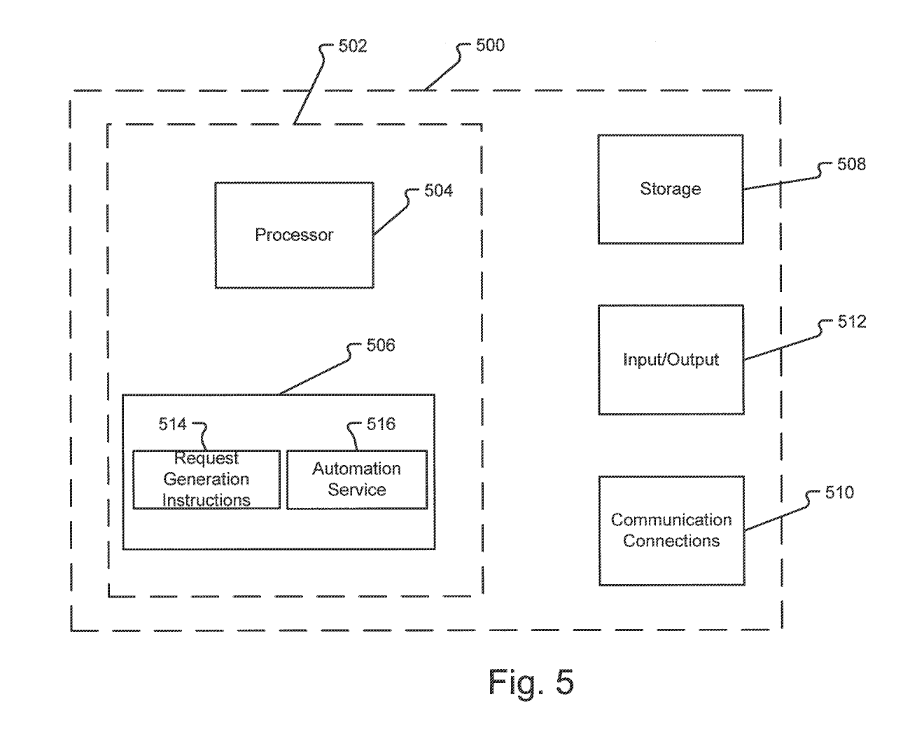

With reference to FIG. 5, an embodiment of a computing environment for implementing the various embodiments described herein includes a computer system, such as computer system 500. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In its most basic configuration, computer system 500 comprises at least one processing unit or processor 504 and system memory 506 The most basic configuration of the computer system 500 is illustrated in FIG. 5 by dashed line 502. In some embodiments, one or more components of the described system are loaded into system memory 506 and executed by the processing unit 504 from system memory 506. Depending on the exact configuration and type of computer system 500, system memory 506 may be volatile (such as RAM), non-volatile (such as ROM, flash memory, etc.), or some combination of the two.

Additionally, computer system 500 may also have additional features/functionality. For example, computer system 500 includes additional storage media 508, such as removable and/or non-removable storage, including, but not limited to, magnetic or optical disks or tape. In some embodiments, software or executable code and any data used for the described system is permanently stored in storage media 508. Storage media 508 includes volatile and non-volatile, removable and non-removable media implemented in any method or technology for storage of information such as computer readable instructions, data structures, program modules, or other data. In embodiments, the computer executable instructions used to perform the methods disclosed herein, such as, but not limited to, the method to respond to an automated request 300 (FIG. 3) and the method to respond to multiple automation requests 400 (FIG. 4) are stored in storage media 508.

System memory 506 and storage media 508 are examples of computer storage media. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage, other magnetic storage devices, or any other medium which is used to store the desired information and which is accessed by computer system 500 and processor 504. Any such computer storage media may be part of computer system 500. In embodiments, system memory 505 and/or storage media 508 stores data used to perform the methods and/or form the system(s) disclosed herein, such as, creating file conversion requests or performing automation services. The various modules described with respect to FIG. 1 may also be stored in system memory 505 and/or storage media 508. In embodiments, system memory 506 stores instructions for performing the methods disclosed herein such as Request Generation Instructions 514 and Automation Service 516.

Computer system 500 may also contain communications connection(s) 510 that allow the device to communicate with other devices. In embodiments, communications connection(s) 510 may be used to transmit and receive messages between sender devices, intermediary devices, and recipient devices. Communication connection(s) 510 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media.

In some embodiments, computer system 500 also includes input and output connections 512, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 512 are used to display the information as described herein. All these devices are well known in the art and need not be discussed at length here.

In some embodiments, the component described herein comprise such modules or instructions executable by computer system 500 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above may also be included within the scope of readable media. In some embodiments, computer system 500 is part of a network that stores data in remote storage media for use by the computer system 500.

This disclosure described some embodiments with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present disclosure. Therefore, the specific structure, acts, or media are disclosed only as illustrative embodiments. The disclosure is defined by the appended claims.

1. A method of performing automation services, the method comprising:
receiving, at a back end sever, a first request for a first file conversion from a first requestor, wherein the first request comprises stream data representing at least one initial file, and wherein the at least one initial file comprises an initial file type;
determining that at least one conversion process from a plurality of conversion processes is idle;
based upon the determination, providing the stream data to the at least one idle process;
generating at least one converted file from the data stream using the at least one idle process;
determining whether the at least one idle process successfully generated the at least one converted file; and
when the at least one idle process successfully generated the at least one converted file, sending the at least one converted file to the requestor.

2. The method of claim 1, wherein the request further comprises request data.

3. The method of claim 2, wherein the request data further comprises conversion options.

4. The method of claim 1, wherein the at least one initial file type comprises at least one of:
an Open Office XML Presentation (.pptx) file; and
a Presentation (.ppt) file.

5. The method of claim 1, wherein the at least one converted file comprises one of:
an Open Office XML Presentation (.pptx) file;
a Presentation (.ppt) file;
a Portable Document Format (.pdf) file;
an XML Paper Specification (.xps) file;
a JPEG (.jpg) file; and
a Portable Network Graphics (.png) file.

6. The method of claim 1, further comprising:
when the at least one idle process failed to successfully generate the at least one converted file, sending an error message to the requestor.

7. The method of claim 1, wherein the first request is a request to perform a batch process file conversion.

8. The method of claim 7, further comprising:
receiving, at the back end server, a second request for a second file conversion;
determining that the second request for the second file conversion is a single file request;
determining that the first batch process file conversion is still in progress; and
prioritizing the single file request over the batch process request, wherein prioritizing the single file request over the batch process request provides for performing the second file conversion before the first file conversion completes.

9. The method of claim 1, wherein the request further comprises conversion option data.

10. A method for requesting presentation file automation services, the method comprising:
generating, at a front end server, a file conversion request by a requestor, the request comprising file conversion options and data representing at least one initial file, wherein the at least one initial file has an initial file type, and wherein generating the request for presentation automation services comprises:
gathering request data, wherein the request data comprises conversion options;
packaging the request and the at least one initial file in a request message, wherein the at least one initial file is packaged as a data stream; and
sending the request message to a back end server for file conversion.

11. The method of claim 10, further comprising receiving, at the front end server, a response from the back end server.

12. The method of claim 11, wherein the response comprises at least one converted file.

13. The method of claim 12, further comprising storing the at least one converted file.

14. The method of claim 11, wherein the response comprises an error message.

15. The method of claim 10, wherein the at least one initial file type is a presentation file, and wherein the file conversion request comprises a request to convert the presentation file into a compressed file comprising at least one image file.

16. A system for performing automation services, the system comprising:
a front end server, the front end server comprising:
a processor; and
memory in electrical communication with the processor, the memory comprising computer executable instructions that, when executed by the processor performs a method comprising:
generating a file conversion request by a requestor, the request comprising file conversion options and data representing at least one initial file, wherein the at least one initial file has an initial file type, and wherein the generating the file conversion request comprises:
gathering request data, wherein the request data comprises conversion options;
determining that the requestor is authorized to access the at least one initial file; and
packaging the request and the at least one initial file in a request message, wherein the at least one initial file is packaged as a data stream; and
sending the request message to a back end server for file conversion.

17. The system of claim 16, further comprising:
a back end server, the back end server comprising:
at least one processor; and
memory in electrical communication with the at least one processor, the memory comprising computer executable instructions, that, when executed by the at least one processor perform a method comprising:
receiving, the request message;
determining that at least one conversion process from a plurality of conversion processes is idle;
based upon the determination, providing the data stream to the at least one idle process;
generating at least one converted file from the data stream using the at least one idle process;
determining whether at least one idle process successfully generated the at least one converted file; and
when the at least one idle process successfully generated the at least one converted file, sending the at least one converted file to the front end server.

18. The system of claim 16, wherein the at least one initial file type comprises at least one of:
an Open Office XML Presentation (.pptx) file; and
a Presentation (.ppt) file.

19. The system of claim 16, wherein the at least one converted file comprises one of:
an Open Office XML Presentation (.pptx) file;
a Presentation (.ppt) file;
a Portable Document Format (.pdf) file;
an XML Paper Specification (.xps) file;
a JPEG (.jpg) file; and
a Portable Network Graphics (.png) file.

20. The system of claim 16, wherein the initial file type and the converted file have different file types.
